(19) United States
(12) Patent Application Publication
(10) Pub. No.: US 2003/0059363 A1
(43) Pub. Date: Mar. 27, 2003

(54) Oxygen enrichment of a sulfuric acid plant furnace

(76) Inventor: Chetan K. Shah, Bridgewater, NJ (US)

Correspondence Address: Philip H. Von Neida, Intellectual Property Dept., The BOC Group, Inc., 100 Mountain Ave., Murray Hill, NJ, 07974, US

(21) Appl. No.: 10/252,588

(22) Filed: Sep. 23, 2002

Related U.S. Application Data
(60) Provisional application No. 60/325,033, filed on Sep. 26, 2001.

(51) Int. Cl. C01B 31/20

(52) U.S. Cl. 423/437.1

(57) ABSTRACT

The present invention provides for the use of oxygen-enriched gas stream injected into a sulfuric acid plant furnace to increase the yield of carbon dioxide. The increased yield of carbon dioxide can then be recovered, purified and processed such that it can be employed in additional processes such as that in the food industry.

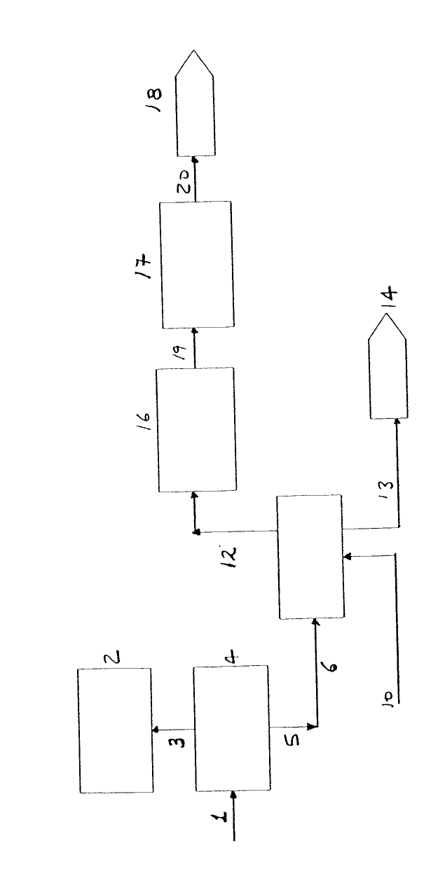

This application claims priority from Provisional U.S. Patent Application No. 60/325,033 filed Sep. 26, 2001.

### FIELD OF THE INVENTION

The present invention provides for a process for enriching the oxygen content of a furnace in a sulfuric acid production plant. More particularly, the present invention provides for increasing the recovery of carbon dioxide from a sulfuric acid plant.

### BACKGROUND OF THE INVENTION

Sulfuric acid is typically made by two major processes, leaden chamber and contact. The leaden chamber process, which is typically used to produce the acid used to make fertilizers, produces a relatively dilute sulfuric acid of 62 to 78%. The contact process produces a purer, more concentrated acid but also requires the use of purer raw materials and catalysts. The lead process or leaden chamber process is the older of the two and is not in use much anymore. In the contact process, purified sulfur dioxide and air are mixed, heated to about 450° C. and passed over a catalyst. The sulfur dioxide is oxidized by the catalyst sulfur trioxide. The catalyst is typically a platinum on silica or as best as carrier or of vanadium pentoxide on a silica carrier. The sulfur trioxide is cooled and passed through two towers. In the first tower it is washed with fuming sulfuric acid and in the second tower it is washed with 97% sulfuric acid. 98% sulfuric acid is usually produced in this tower. The desired concentration acid may be produced by mixing or diluting the sulfuric acid made by this process.

In the catalytic oxidation stage, sulfur dioxide and oxygen in the process gas stream are converted to sulfur trioxide by a heterogeneous type reaction. This is a catalyst-driven reaction and the catalyst is typically of vanadium or potassium sulfate catalyst supported on a diatomaceous earth carrier. However, other catalysts such as vanadium-type catalysts are also known in this process. After conversion of the sulfur dioxide to sulfur trioxide, the sulfur trioxide is reacted with water to form sulfuric acid in an SO₃ adsorption zone wherein the adsorption media is strong sulfuric acid solution. While reaction of SO₃ with the water portion of the concentrated sulfuric acid is rapid and virtually complete, SO₂ is removed from the gas phase to a lesser extent to form sulphurous acid in the concentrated sulfuric acid media.

Another of the byproducts from the sulfuric acid plant is carbon dioxide. Typically, though, this carbon dioxide is not recovered from the purged gas because of its low concentration in the purged gas. The present inventors have discovered that the use of higher concentrations of oxygen added to the sulfuric acid plant will produce a higher concentration of carbon dioxide in the purged gas while not exceeding the maximum temperature of the catalyst converting sulfur dioxide to sulfur trioxide in the sulfuric acid plant.

### SUMMARY OF THE INVENTION

Carbon dioxide yield in the purged gas from a sulfuric acid production facility is increased by the addition of enriched oxygen to the sulfuric acid plant. This increase in oxygen content results not only in a higher carbon dioxide concentration in the stack gas leaving the plant but also will inhibit the increase in the maximum temperature at which the catalyst converts sulfur dioxide to sulfur trioxide. The CO₂ recovered from the purged gas can then be purified and passed through a carbon dioxide liquefaction plant which can yield food grade carbon dioxide.

### BRIEF DESCRIPTION OF THE DRAWINGS

The FIGURE is a schematic representation of a sulfuric acid plant detailing the process of the present invention.

### DETAILED DESCRIPTION OF THE INVENTION

The present invention is directed to a process for increasing the recovery of carbon dioxide from a sulfuric acid plant furnace comprising injecting oxygen into the furnace. It has been discovered that by increasing the oxygen content over that of air, which is traditionally inputted into the sulfuric acid plant furnace, that nitrogen presence in the feed is reduced and higher carbon dioxide concentration in the stack gas will result. This process will also operate such that the catalyst temperature does not rise above that which would damage the catalyst and damage the conversion of the sulfur dioxide to sulfur trioxide. Typically, this temperature is less than 2100° F. but can be greater than this if the reformer refractory is modified to withstand higher temperatures. The enriched oxygen stream which is injected into the sulfuric acid plant furnace will contain about at least 60% by volume oxygen. This oxygen stream can be obtained from any standard source such as oxygen obtained from pressure swing adsorption, temperature swing adsorption, vacuum swing adsorption or vacuum pressure swing adsorption.

These processes are preferably cyclic adsorption processes. Regeneration of the adsorbents used in the invention may also be affected by purging the beds with or without pressure and/or temperature change during the regeneration step relative to the adsorption step of the process. The temperature at which the adsorption step is carried out may vary over a wide range. For example, from a minimum temperature of about −50° C. to a maximum of about 200° C. It is generally preferred, however, that the adsorption temperature be in the range of about 0 to about 80° C. and most preferably in the range of about 5 to about 40° C.

The pressure at which the adsorption step can be carried out varies over a wide range. For pressure swing adsorption cycles, the adsorption step is generally carried out at a pressure in the range of about 0.8 to about 50 bara (bar absolute) and is preferably carried out at a pressure in the range of about 1 to 20 bara and for temperature swing adsorption cycles, the adsorption step is usually carried out at or above atmospheric pressure. When the adsorption process is PSA, the regeneration step is generally carried out at temperatures in the neighborhood of the temperature at which the adsorption step is carried out and at an absolute pressure lower than that of the adsorption pressure. The pressure during the regeneration step of PSA cycles is usually in the range of about 0.1 to above 5 bara and it is preferably in the range of about 0.2 to about 2 bara during regeneration. The regeneration phase may be a multi-step procedure which includes a depressurization step during which the vessels containing the adsorbent are vented until they obtain the desired lower pressure and an evacuation step during which the pressure in the vessels is reduced to sub-atmospheric pressure by means of a vacuum inducing device such as a vacuum pump.

When the adsorption process is TSA, bed regeneration is carried out at a temperature higher than the adsorption temperature and is usually carried out at temperatures in the range of about 50 to about 300° C. and is preferably carried out at temperatures in the range of about 100 to 250° C. When a combination of PSA and TSA is used, the temperature and pressure in the bed regeneration step are higher and lower, respectively, than they are during the adsorption step. The adsorbents employed in the process in the present invention typically include zeolites, mesopore structure materials, carbon molecular sieves and other inorganic porous materials such as metal oxides and mixtures thereof.

The process of the instant invention would have applicability not only in facilities that directly manufacture sulfuric acid but also those facilities where sulfur components such as H₂S and SO₂ are removed from emissions and converted to a sulfuric acid product. Typical of these installations would be power plants and other facilities that burn coal.

Reference will now be made to the FIGURE which should be construed not as limiting but exemplary of the present invention.

Syngas which comprises hydrogen and carbon dioxide is directed through line 1 from a gasifier not shown to the acid gas system 4. The syngas will react with the acid gas system containing MDEA and will exit through line 5 to line 6 to the sulfuric acid plant 12. Clean syngas meanwhile will leave via line 3 from the acid gas system to, for example, a power generation system 2. This acid gas, which contains mostly H₂S and carbon dioxide with a concentration of about 85 mole %, is sent to the sulfuric acid plant to be burned. H₂S will convert to SO₂ where air is inputted as the source of oxygen. This SO₂ is further reacted to SO₃ in subsequent reactors not shown in the sulfuric acid plant and will leave the inert components particularly nitrogen and carbon dioxide unreacted.

Line 10 provides the oxygen-enriched gas which can be derived from any oxygen source not shown. Line 13 exits the sulfuric acid plant with concentrated sulfuric acid and sent to 14 which can be a holding tank or other container for the sulfuric acid prior to further processing. Line 15 will exit the sulfuric acid plant and contain primarily raw carbon dioxide which is approximately 80% by volume. This raw carbon dioxide will enter a CO₂ purification unit 16. The CO₂ purification unit is typically a soda scrubber which will remove the sulfur dioxide present in the stack gas stream. The CO₂ that remains is compressed using any standard screw compressor and is directed through line 19 to the liquid carbon dioxide plant 17. The liquid CO₂ will be further purified within the liquid CO₂ plant and is lastly passed through line 20 to 18. The concentration of the oxygen in the oxygen-enriched stream can be anywhere above that which is typically found in atmospheric air. However preferably, the amount of oxygen is greater than 50 volume % and most preferably greater than 65 volume %. This amount of oxygen-enriched gas will achieve greater than 80 volume % carbon dioxide in the stack gas which would allow straight carbon dioxide cryogenic purification.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the present invention.

Having thus described the invention, what I claim is:

1. A process for increasing the recovery of carbon dioxide from a sulfuric acid plant furnace comprising injecting an oxygen-enriched gas stream into said furnace.

2. The process as claimed in claim 1 wherein the feed to said furnace comprises hydrogen sulfide and carbon dioxide.

3. The process as claimed in claim 2 wherein said carbon dioxide is present in 85 mole % in said feed.

4. The process as claimed in claim 1 wherein the temperature of the said furnace is less than 2100° F.

5. The process as claimed in claim 1 wherein the oxygen content of said oxygen-enriched gas stream is greater than that of atmospheric air.

6. The process as claimed in claim 5 wherein the oxygen content of said oxygen-enriched gas stream is greater than 50 volume %.

7. The process as claimed in claim 6 wherein the oxygen content of said oxygen-enriched gas stream is greater than about 60 volume %.

8. The process as claimed in claim 5 wherein said oxygen is from a pressure swing adsorption process, temperature swing adsorption process, vacuum swing adsorption process or vacuum pressure swing adsorption process.

9. The process as claimed in claim 1 wherein said carbon dioxide recovered is passed through a soda scrubber.

10. The process as claimed in claim 9 wherein said carbon dioxide is compressed and liquefied.

11. The process as claimed in claim 10 wherein said compressed carbon dioxide is passed through further separation means.

12. The process as claimed in claim 1 wherein said recovered carbon dioxide is food grade carbon dioxide.

13. The process as claimed in claim 1 wherein said furnace is in a power plant or other coal burning facility.

14. A process for increasing the recovery of carbon dioxide from a sulfuric acid plant furnace having a catalyst therein without exceeding the temperature at which said catalyst is deactivated comprising injecting an oxygen-enriched gas stream into said furnace.

15. The process as claimed in claim 14 wherein said catalyst is for converting sulfur oxides to higher orders of sulfur oxides.

16. The process as claimed in claim 14 wherein the feed to said furnace comprises hydrogen sulfide and carbon dioxide.

17. The process as claimed in claim 16 wherein said carbon dioxide is present in 85 mole % in said feed.

18. The process as claimed in claim 14 wherein the temperature of the said furnace is less than 2100° F.

19. The process as claimed in claim 14 wherein the oxygen content of said oxygen-enriched gas stream is greater than that of atmospheric air.

20. The process as claimed in claim 14 wherein said recovered carbon dioxide is food grade carbon dioxide.
